(19) United States
(12) Patent Application Publication
(10) Pub. No.: US 2026/0347058 A1
(43) Pub. Date: Nov. 5, 2026

(54) Sealing Assembly for a Closure

(71) Applicant: Manfred Imand Kurmis, Blackwood (AU)

(72) Inventor: Manfred Imand Kurmis, Blackwood (AU)

(21) Appl. No.: 19/194,526

(22) Filed: Apr. 30, 2025

(51) Int. Cl. B65D 41/04; B67B 3/20

(52) U.S. Cl. CPC B65D 41/0435; B67B 3/20

(57) ABSTRACT

A sealing assembly provides a secure, reusable closure for containers holding wine, carbonated beverages, and fluids. The assembly includes a rigid cap portion with a two-start internal thread that engages the threaded neck of a container using fewer turns while distributing load around the closure. A flexible insert is retained within the cap and contacts the inside wall of the container opening to form a pressure-resistant seal. The insert can rotate relative to the cap and includes a flexible skirt and sealing fin that respond to internal pressure to strengthen the seal. Grooves formed around the cap allow trapped air to escape during assembly, collect excess adhesive, and assist removal from a mold. The assembly may be installed within a roll-on pilfer-proof closure using automated equipment or applied manually. It also supports controlled pressure release when opened and can be removed and reapplied while maintaining sealing performance over repeated uses.

### FIELD OF THE INVENTION

Embodiments of the present invention generally relate to closures for sealing an opening of a container. More particularly, the present invention pertains to a sealing assembly for a closure, designed to provide secure sealing engagement with the opening of a container. In one form, the invention is particularly suited for use in sealing wine bottles and other bottled carbonated beverages, ensuring effective fluid containment, pressure management, and resealability. The sealing assembly is further configured to be compatible with roll-on pilfer-proof (ROPP) closures and other conventional capping mechanisms, facilitating reliable application across various bottling and packaging systems.

### BACKGROUND

Ensuring a secure and reliable seal for bottled carbonated beverages, particularly wine, presents several challenges related to preserving product integrity, preventing leakage, and maintaining ease of resealability. A proper closure must provide an effective barrier against oxidation, contamination, and pressure variations while also accommodating high-speed production and consumer convenience. Additionally, closures must be capable of maintaining a tight seal over extended storage periods, preventing fluid loss or degradation of the beverage quality. Achieving these sealing requirements while also ensuring compatibility with standard bottling equipment and production line efficiency remains a persistent challenge in the industry.

Various closure technologies have been developed to address these sealing challenges, including traditional corks, synthetic corks, screw caps, and composite sealing systems. Traditional cork stoppers have been widely used due to their ability to create a tight seal; however, they are prone to cork taint and inconsistent sealing performance. Synthetic corks attempt to mitigate these issues but often lack the compressibility and elasticity of natural cork, leading to sealing inconsistencies. Screw caps with integrated liners and sealing assemblies have gained popularity due to their reliable sealing properties and ease of use, particularly in roll-on pilfer-proof (ROPP) closures. Many modern closures also incorporate sealing inserts or flexible skirt portions to enhance the seal against the bottle's interior surface.

Despite these advancements, existing solutions present several limitations. Cork closures can degrade over time, leading to air ingress and product spoilage. Synthetic corks and some composite closures may struggle to maintain consistent sealing pressure, especially under varying storage conditions. Screw caps, while effective, can sometimes suffer from seal failure due to liner misalignment, thread wear, or pressure fluctuations within the bottle. Additionally, high-speed bottling lines require closures that minimize air entrapment and ensure proper cap retention during application, which is often not adequately addressed by conventional sealing technologies. Furthermore, adhesive-based sealing assemblies may experience glue overflow or inconsistent bonding, compromising both the sealing integrity and manufacturing efficiency.

Given these shortcomings, there remains a strong need for a sealing assembly that provides a consistently effective seal, accommodates modern bottling processes, and enhances product preservation. An ideal solution should overcome the deficiencies of existing technologies by offering improved sealing engagement, air venting capabilities, and reliable retention within the closure shell, all while ensuring compatibility with high-speed production lines and various capping methods.

### SUMMARY

According to one aspect of the invention, there is provided a sealing assembly for a closure, the closure for applying to an opening of a container of fluid. The sealing assembly comprises a substantially rigid cap portion for seating the sealing assembly within a roof portion of a closure shell. The cap portion includes a flattened cylindrically shaped body and a downwardly extending cylindrical skirt, the cylindrical skirt incorporating an internal two-start thread for engagement with an external thread of the container. The sealing assembly further comprises an insert portion that is attachable to the cap portion. The insert portion includes a skirt portion, the skirt portion being flexible relative to the cap portion and extending from the insert portion, the skirt portion operable to contact an inner wall region of the opening upon application of the closure to the opening.

The cap portion further comprises a centrally disposed attachment region to which the insert portion is attached. In addition, the insert portion includes an annular retention flange positioned between the central attachment region and the skirt portion, the annular retention flange engaging a radially inwardly extending projection of the cap portion. This engagement prevents axial movement of the insert portion relative to the cap portion while allowing the insert portion to rotate relative to the cap portion. The insert portion skirt is biased against the inner wall region of the opening upon application of the closure to the opening. The insert portion further comprises a circumferentially flexible sealing fin-extending outwardly from an outer surface of the skirt portion, the flexible sealing fin enhancing sealing engagement with the inner wall region of the opening upon application of the closure to the opening. The cap portion additionally comprises a plurality of circumferentially distributed grooves in an axial direction along an outer surface of the cylindrical skirt. The cap portion is configured to maintain a preloaded engagement with the insert portion such that the sealing assembly remains securely positioned within the closure shell during application and roll forming.

In accordance with an embodiment of the present invention, the annular shaped wall portion of the cap portion is received in a corresponding channel in the insert portion, the channel surrounding the central attachment region of the insert portion to increase the rigidity of a central region of the insert portion relative to the skirt portion of the insert portion. In another embodiment, the insert portion is permanently and rotatably attached to the cap portion such that the insert portion remains attached to the cap portion when the sealing assembly is removed from the opening. Additionally, the annular retention flange of the insert portion may be formed as an integrally molded component of the insert portion.

In another embodiment, the skirt portion of the insert portion is configured to flex radially inwardly upon application of the closure to the opening, thereby enhancing sealing pressure between the insert portion and the inner wall region of the opening. Additionally, the flexible sealing fin of the insert portion designed to have a secondary sealing affect under gas pressure after application of the closure to the opening, thereby increasing the sealing effectiveness of the insert portion against the inner wall region of the opening.

In one embodiment, the cap portion is formed of a rigid polymeric material comprising a glass-filled polymer for enhanced strength and reduced thermal expansion. In addition, the insert portion is formed of a thermoplastic elastomer, providing flexibility and sealing performance. The two-start thread of the cap portion is configured to reduce the number of rotations required to fully secure the closure to the opening. Additionally, the two-start thread configuration ensures balanced load distribution during application and removal of the closure, further improving axial load-bearing strength and resistance to failure when subjected to internal pressure within the container.

Additionally, in some embodiments, the plurality of circumferentially distributed grooves in an axial direction along the cylindrical skirt of the cap portion are configured to facilitate air venting during application of the sealing assembly to the closure shell. The grooves further function as a glue reservoir to accommodate excess adhesive used to secure the insert portion to the cap portion.

In accordance with an embodiment of the present invention, the cap portion and insert portion are adapted for assembly within a roll-on tamper-evident closure, which is applied to the opening using a roll-on pilfer-proof (ROPP) capping head. Alternatively, the cap portion and insert portion assembly (without a POPP shell) adapted for manual application, allowing the closure to be screwed onto the opening by hand without requiring an ROPP capping head. The cap portion and insert portion together form a resealable and reusable closure, that also can be applied to the container.

According to another aspect of the invention, there is provided a method for sealing an opening of a container containing a fluid. The method comprises applying a closure to the opening, the closure comprising a sealing assembly that includes a cap portion and an insert portion. The cap portion includes a flattened cylindrically shaped body and a downwardly extending cylindrical skirt, the cylindrical skirt incorporating an internal two-start thread for engagement with an external two-start thread of the container. The insert portion includes a skirt portion that is flexible relative to the cap portion and operable to contact an inner wall region of the opening upon application of the closure to the opening.

The method further comprises securing the cap portion to the insert portion at a centrally disposed attachment region. Additionally, the insert portion includes an annular retention flange positioned between the central attachment region and the skirt portion, the annular retention flange engaging a radially inwardly extending projection of the cap portion, thereby preventing axial movement of the insert portion attachment relative to the cap portion while still allowing the insert portion to rotate relative to the cap portion.

The method also includes a step of ensuring that the cap portion maintains a preloaded engagement with the insert portion so that the sealing assembly remains securely positioned within the closure shell during roll forming and application. In one embodiment, the closure is applied to the opening using a roll-on pilfer-proof (ROPP) capping head. In another embodiment, a-closure that doesn't requiring the ROPP, can be manually screwed on by hand onto the opening, providing an optional alternative.

According to another aspect of the invention, there is provided a container sealed by a closure, the closure comprising a sealing assembly as described in the embodiments above.

### BRIEF DESCRIPTION OF THE DRAWINGS

FIG. 1 illustrates a cutaway part-sectional side view of a container assembly;

FIG. 2 illustrates a side sectional view of the sealing assembly and a closure shell of the container;

FIG. 3A-3B illustrate a side sectional view and a half side sectional view of the sealing assembly, respectively;

FIG. 4 illustrates a bottom view of a cap portion, including sectional views along Y-Y and Z-Z;

FIG. 5 illustrates a schematic representation of the load balance of two-start threads; and

FIG. 6 illustrates a sectional view of the closure assembly during the manufacturing and assembly process.

### DETAILED DESCRIPTION

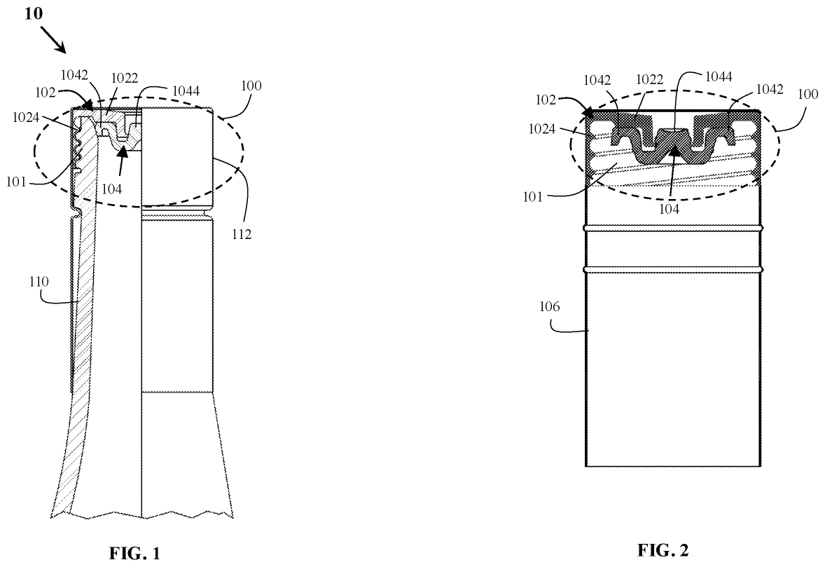

In FIG. 1, there is shown a cutaway part-sectional side view of a container 10 (or sometimes referred as container assembly) in accordance with an illustrative embodiment of the present invention. In this embodiment, the container 10 includes a neck 110 terminating in an opening that is configured to receive a closure assembly. The neck 110 further incorporates an external thread 101, which is adapted to engage a corresponding internal thread of a closure to provide a secure attachment between the container and the closure. The container 10 may be formed from glass, plastic, or other suitable materials commonly employed in the packaging of pressurized or non-pressurized beverages, such as wine, sparkling beverages, and other liquid products.

Positioned around the neck 110 of the container is an outer sleeve 112, which serves both functional and aesthetic purposes. The outer sleeve 112 may be configured to provide tamper-evident protection, branding, or additional reinforcement to the container neck. In some embodiments, the outer sleeve 112 may be crimped or roll-formed in conjunction with the application of the closure to enhance retention and security.

As shown in FIG. 1, the closure assembly includes a sealing assembly 100, which is structured to engage the opening of the container 10 and provide an effective sealing mechanism. The sealing assembly 100 is designed to prevent leakage, maintain product integrity, and provide resealability after initial opening. The sealing assembly 100 includes a cap portion 102 which forms a substantially rigid structure, which seats within the roof portion of the closure shell. The cap portion 102 includes a flattened cylindrically shaped body 1022 and an integrally formed cylindrical skirt 1024, which extends downwardly from the body 1022 and engages with the external thread 101 of the container 10. The internal surface of the cylindrical skirt 1024 is formed with an internal two-start thread, which enables engagement with the external thread 101 of the container 10 in a manner that enhances load balance, axial stability, and ease of application.

To facilitate high-speed assembly and enhanced mechanical performance, the cap portion 102 further comprises a plurality of external circumferentially distributed grooves 1026, extending along the axial direction of the cylindrical skirt 1024. These grooves serve multiple functional purposes, including air venting, adhesive overflow management, and ease of cap extraction during injection molding. The grooves 1026 ensure that when the sealing assembly 100 is pressed into the closure shell, air pressure buildup is minimized, allowing for smooth and precise positioning of the closure within the shell.

The sealing assembly 100 further incorporates an insert portion 104, which is attached to the cap portion 102 to form a composite sealing system. The insert portion 104 includes a skirt portion 1042, which extends downwardly and is flexible relative to the cap portion 102. The skirt portion 1042 is designed to engage an inner wall region of the opening of the container 10, providing an initial seal upon application and further enhancing sealing engagement under internal pressure conditions. Positioned between the central attachment region of the cap portion 102 and the skirt portion 1042 of the insert portion 104 is an annular retention flange 1044, which functions to secure the insert portion within the cap portion while allowing relative rotation between the two components.

In operation, the sealing assembly 100 is designed to be applied to the neck 110 of the container 10 via a roll-on pilfer-proof (ROPP) capping head or manual screwing, depending on the application. The two-start thread configuration of the cylindrical skirt 1024 allows for a balanced load distribution, reducing the number of turns required for full engagement while ensuring a consistent axial alignment during closure application. The presence of the flexible skirt portion 1042 ensures that the seal is dynamically maintained, adapting to pressure variations within the container and providing a secondary sealing effect when internal pressure is exerted against the skirt.

The container assembly 10, in combination with the sealing assembly 100, provides an effective, durable, and reusable closure system suitable for various pressurized and non-pressurized applications. The structural integration of the cap portion 102, insert portion 104, and closure shell ensures long-term sealing performance, while the material composition of the sealing assembly can be selected to accommodate food safety requirements, mechanical durability, and thermal stability.

Each of these components will now be seen and discussed in more details with reference to the subsequent drawings.

Referring now to FIG. 2, there is shown a side sectional view of the sealing assembly 100 positioned within the closure shell, illustrating its integration within the closure structure. The cap portion 102 and insert portion 104 collectively form a composite sealing assembly configured to be secured within the roof region of the closure shell. The cap portion 102, which is structurally rigid, is shaped to fit precisely within the internal cavity of the closure shell, ensuring stability and retention during both application and removal of the closure.

The cylindrical skirt 1024 of the cap portion 102 extends downwardly and incorporates an internal two-start thread, which is designed to engage with the external thread 101 of the container 10 (as previously shown in FIG. 1). The two-start thread configuration enhances load distribution and reduces the number of rotations required to secure the closure, thereby facilitating efficient application and removal.

The insert portion 104, positioned within the cap portion 102, is attached through a centrally disposed attachment region 1032. The skirt portion 1042 of the insert portion 104 extends downwardly and is flexible relative to the cap portion 102, allowing it to conform to the inner wall region of the container opening upon application. This flexibility enhances sealing effectiveness, especially in applications where internal pressure variations occur.

To maintain secure positioning within the cap portion 102, the insert portion 104 includes an annular retention flange 1044, which is configured to engage a radially inwardly extending projection within the cap portion 102. This engagement prevents axial displacement of the insert portion while allowing relative rotational movement between the cap portion 102 and the insert portion 104. This functional relationship ensures that when the closure is unscrewed, the insert portion remains engaged against the sealing surface of the container opening until a sufficient vertical upward movement occurs, enabling a controlled pressure venting release mechanism.

The closure shell, 106 which houses the sealing assembly 100, is structured to retain the cap portion 102 through mechanical interference, adhesive bonding, or other securing methods. In certain embodiments, the closure shell may be applied to the container via a roll-on pilfer-proof (ROPP) capping process, wherein the shell is mechanically deformed to conform to the threaded neck of the container. The cap portion 102 remains secured securely preloaded within the closure shell, ensuring stability and sealing integrity throughout the lifecycle of the closure.

As further depicted in FIG. 2, the cylindrical skirt 1024 of the cap portion 102 features circumferentially distributed grooves 1026 along its axial direction. These grooves are configured to prevent air entrapment during high-speed cap application, serve as a glue reservoir for excess adhesive, and facilitate mold extraction during injection molding. The structural features of the sealing assembly 100, as shown in FIG. 2, ensure consistent sealing performance, controlled pressure release, and high-speed assembly compatibility, making it suitable for both manual and automated bottling applications.

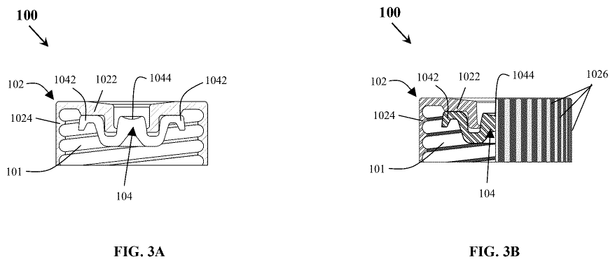

Referring now to FIGS. 3A and 3B there are shown a side, and a half side sectional views of the sealing assembly 100, respectively, illustrating the cap portion 102 and insert portion 104 in greater structural detail. The sealing assembly 100 is designed to provide a reliable sealing interface with the container opening, ensuring fluid containment, pressure management, and resealability. Also can be screwed on manually by hand if no ROPP shell is required

The cap portion 102, which forms the rigid structural base of the sealing assembly, comprises a flattened cylindrically shaped body 1022, extending into a cylindrical skirt 1024. The cylindrical skirt 1024 is internally threaded with a two-start thread configuration, which engages with the external thread of the container, as previously described in FIG. 2. This threading mechanism enables quick and secure application while maintaining balanced axial force distribution.

In a preferred embodiment, the cap portion 102 is formed from a rigid polymeric material, such as NORYL-GFN2, a 20% glass-fiber reinforced polyphenylene ether (PPO) material. This composition is selected due to its high tensile strength, low thermal expansion, and superior mechanical stability, ensuring that the cap portion resists deformation under high-pressure conditions. The glass-filled structure enhances rigidity, making the closure suitable for both automated ROPP application and high-pressure bottling environments while withstanding pasteurization temperatures up to 72 °C.

Positioned within the cap portion 102 is the insert portion 104, which is configured to interact with the inner sealing surface of the container opening. The insert portion 104 is secured within the cap portion 102 through a centrally disposed attachment region 1032, which ensures proper alignment and retention.

Extending downward from the insert portion 104 is a skirt portion 1042, which is flexible relative to the cap portion 102. This flexibility allows the skirt portion 1042 to conform to variations in the inner wall surface of the container opening, providing an initial sealing engagement upon application. Additionally, the skirt portion 1042 is structured to respond to internal pressure fluctuations within the container, enhancing sealing effectiveness as pressure increases.

Between the central attachment region 1032 and the skirt portion 1042 of the insert portion 104 is an annular retention flange 1044. This flange is configured to engage a radially inwardly extending projection within the cap portion 102, thereby preventing axial displacement of the insert portion 104 while allowing for relative rotational movement. This functional relationship ensures that when the closure is unscrewed, the insert portion 104 remains engaged with the container opening until sufficient pressure venting occurs, facilitating a controlled release of internal pressure.

In certain embodiments, the insert portion 104 and the inner wall of the container opening, ensuring a consistent and reliable seal, even in the presence of manufacturing tolerances or irregularities in the container neck.

In a preferred embodiment, the insert portion 104, is preferably manufactured from a thermoplastic elastomer (TPE), or similar flexible materials.

As seen in FIG. 3, the sealing assembly 100 is structured to be preloaded within the closure shell 106 (as previously described in FIG. 2), ensuring secure retention during application, use, and removal. The combination of a rigid cap portion 102, a flexible insert portion 104, and a structured engagement mechanism allows for a highly effective sealing solution, capable of handling both pressurized and non-pressurized applications.

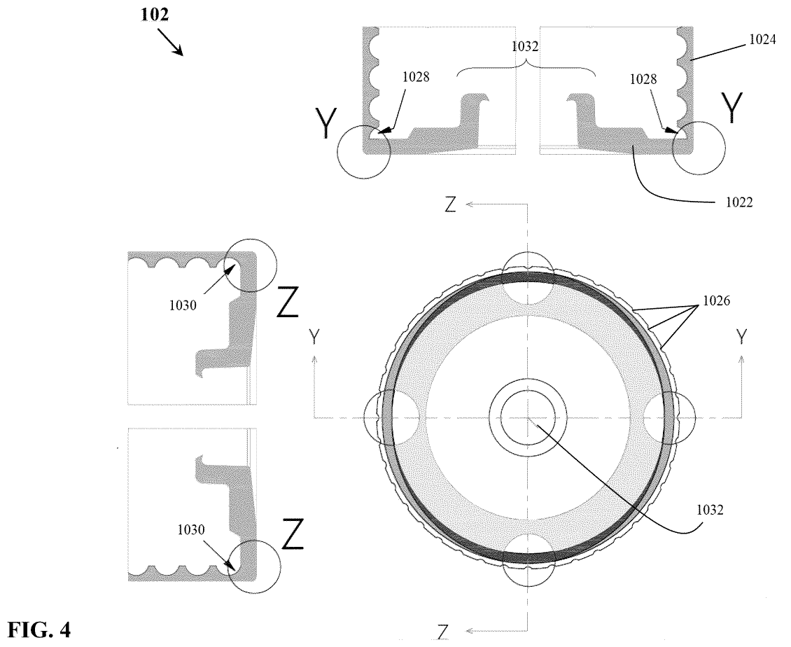

Referring now to FIG. 4, there is shown a bottom view of the cap portion 102, along with sectional views Y-Y and Z-Z, illustrating key structural details of the attachment region and peripheral design elements. These design aspects contribute to the mechanical stability, sealing performance, and manufacturability of the sealing assembly.

As depicted in FIG. 4, the cap portion 102 features a centrally disposed attachment region 1032, which is designed to receive and secure the insert portion 104. The attachment region 1032 may include a recess, aperture, or projection engagement feature, depending on the embodiment, facilitating precise alignment and firm retention of the insert portion within the cap portion. The design of this attachment region ensures that the insert portion 104 remains preloaded within the cap portion 102, preventing unintended displacement while still allowing relative rotational movement when necessary.

The bottom view of the cap portion 102 further reveals circumferentially distributed sharp corners 1028, which are distinctly visible in the Y-Y sectional view. These sharp corners functions, particularly aid the in-injection molding processes. Specifically, these corners contribute to mold extraction efficiency, ensuring that the cap portion can be cleanly ejected from the mold without deformation, in turn and aids in secure positioning within the closure shell 106, ensuring that the cap portion does not shift or misalign during assembly or application.

In contrast, the Z-Z sectional view illustrates rounded corners 1030, which play a critical role in reducing stress concentrations and improving structural resilience. By incorporating these rounded edge profiles, the cap portion 102 is able to withstand mechanical stresses encountered during high-speed capping, transportation, and consumer handling. Additionally, these ensure an even distribution of forces when the sealing assembly is applied to a container opening.

The combination of sharp and rounded corner profiles in FIG. 4 provides a balanced structural configuration, optimizing the cap portion 102 for both manufacturability and functional performance. The rounded corners prevent stress fractures and material fatigue, particularly in high-pressure applications.

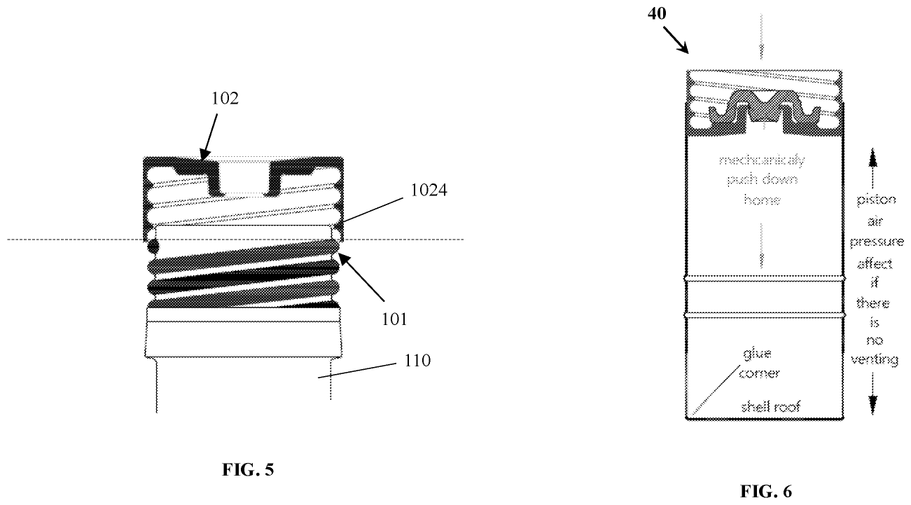

Referring now to FIG. 5, there is shown a schematic representation of the load balance characteristics of the two-start thread configuration, illustrating the structural and functional advantages of this design in relation to closure application, sealing performance, and removal efficiency.

The cap portion 102 of the sealing assembly incorporates a two-start internal thread, which is designed to engage with the external thread 101 of the container 10 (as previously shown in FIGS. 1 and 2). Unlike traditional single-start thread designs, where a single continuous thread winds around the circumference of the cap portion, the two-start thread configuration features two parallel thread paths that begin 180 degrees apart. This design introduces several mechanical advantages, particularly in terms of load balance, alignment, and sealing pressure distribution.

One of the primary benefits of the two-start thread is its ability to distribute mechanical loads more evenly across the closure and the container neck. As depicted in FIG. 5, the two-thread engagement ensures that opposite points of contact are established simultaneously, preventing asymmetrical stress concentration on one side of the closure. This balanced distribution results in greater axial stability, reducing the likelihood of thread misalignment, uneven sealing pressure, or localized mechanical failure.

Additionally, the two-start thread configuration allows for a greater overall thread engagement length within the same axial height, effectively increasing the load-bearing capacity of the closure. This feature is particularly advantageous in pressurized applications, where internal forces exert outward pressure on the closure assembly. The additional engagement area enhances the cap's resistance to pressure-induced deformation, ensuring that the sealing integrity remains intact even at elevated temperatures and internal pressures.

A further functional advantage of the two-start thread configuration is its reduction in the number of turns required to fully engage or disengage the closure. Whereas a single-start thread would require multiple revolutions to secure or remove the cap, the two-start thread allows the closure to be fully secured with just one complete rotation (360 degrees). This feature enhances user convenience, particularly in high-speed bottling applications where rapid closure application is essential. Moreover, in manual applications, such as home brewing or small-batch production, the ease of opening and resealing is significantly improved, contributing to an overall better user experience.

The two-start thread design also enhances the performance of the insert portion 104, as it ensures that the axial movement of the closure is more consistent and perpendicular to the sealing surface of the container opening. This controlled movement allows the skirt portion 1042 of the insert to engage more uniformly with the inner sealing surface, thereby enhancing the effectiveness of the seal and reducing the risk of leakage.

By incorporating the two-start thread configuration, the present invention provides a structurally optimized closure solution that not only facilitates secure and reliable sealing but also enhances application efficiency and user handling. This feature, as depicted in FIG. 5, is particularly beneficial in high-pressure beverage applications, ensuring that the closure assembly remains robust, balanced, and user-friendly across various sealing conditions.

Referring now to FIG. 6, there is shown a detailed sectional view of the cap portion 102, highlighting key design features that contribute to efficient manufacturing, assembly precision, and sealing performance. This figure particularly illustrates the circumferentially distributed grooves 1026, which serve multiple essential functions, including simplified mold extraction, air venting during assembly, and excess adhesive management.

A primary function of the grooves 1026, as depicted in FIG. 4, is to facilitate cap extraction during injection molding. The cap portion 102 is produced using a spindle-based injection molding process, where the threaded spindle end face design provides a very simple effective cap extraction method. The cap circumferentially grooves 1026 die engagement structure prevents the cap from rotating, only axial linear movements will occur when the spindle is rotated. This controlled movement, dictated by the helix angle of the internal threads, ensures linear movement, displacement per revolution, reducing the need for complex ejector pin mechanisms. Notably, the profiled sharp corners 1028, formed by the spindle thread face design, are critical to achieving a successful extraction, as they prevent deformation or binding during the extraction process. Alternative extraction methods without this feature would require significantly more complex tooling, increasing production costs and defect rates.

Beyond molding efficiency, the grooves 1026 also play a crucial role in air venting during assembly of the closure shell. During high-speed production, the sealing assembly 100, preassembled with the insert portion 104 and cap portion 102, is mechanically inserted into the closure shell. If the outer surface of the cap portion 102 had a completely smooth profile, rapid insertion would create a piston effect, trapping air between the sealing assembly and the shell interior. This compressed air could generate back pressure, causing partial displacement of the sealing assembly within the closure shell. The grooves 1026 alleviate this issue by providing venting channels, allowing air to escape as the cap portion is pressed into its seated position. This feature ensures that the cap portion remains securely positioned within the closure shell without unwanted shifting or misalignment. This is particularly beneficial for high-speed automated assembly lines, where precise component placement and consistency are critical.

In addition to aiding molding and venting, the grooves 1026 also function as an adhesive management system. In some embodiments, hot-melt adhesive is applied to the inner roof region corner only on one side of the closure shell before inserting the sealing assembly 100. Due to tight tolerances between the cap portion 102 and the closure shell, only a thin adhesive film is required to create a strong bond. However, during the mechanical insertion process, any excess adhesive could spread beyond the intended bonding area, potentially interfering with the sealing elements of the insert portion 104. The grooves 1026 act as reservoirs for this excess adhesive, collecting and containing the displaced material. This prevents adhesive overflow, ensures a clean bond without affecting functional components, and enhances the long-term stability of the closure assembly.

Thus, as illustrated in FIG. 4, the integration of the circumferential grooves 1026 into the cap portion 102 provides a multi-functional advantage that extends beyond basic sealing. These grooves optimize the manufacturing process, facilitate precise assembly, and enhance sealing reliability, making the closure assembly highly efficient for both industrial-scale bottling and manual application scenarios.

### Exemplary Method of Manufacturing, Application and Operation

Following the detailed discussion of the structural and functional aspects of the sealing assembly, it is now appropriate to consider the methods of manufacturing, and application of the closure system. The effectiveness of the closure in maintaining a secure and pressure-resistant seal is inherently linked not only to its structural configuration but also to the manner in which it is fabricated, assembled, and applied to a container. The interaction between the cap portion, insert portion, and the external closure shell must be precisely controlled to ensure proper functionality under varying operational conditions, whether the closure is applied using automated industrial equipment or manually by an individual.

The manufacturing process of the sealing assembly begins with the formation of its primary components, namely the cap portion and the insert portion, which are produced through injection molding. The cap portion, being a rigid structural element designed to provide stability to the closure, is preferably formed from a glass-filled polymeric material, such as NORYL-GFN2, ensuring dimensional stability and resistance to deformation under high pressures and elevated temperatures. The insert portion, in contrast, is fabricated from a thermoplastic elastomer material, to provide the required flexibility for sealing engagement. Once molded, the insert portion is assembled into the cap portion by engaging the annular retention flange with the radially inward projection of the cap portion. This engagement prevents axial movement while allowing relative rotational movement between the components.

Once the sealing assembly is fully manufactured and assembled, it is integrated into a closure shell and applied to a container.

Furthermore, the application process varies depending on whether the closure is installed using an industrial roll-on pilfer-proof (ROPP) capping machine or applied manually. In a high-speed production setting, the closure is positioned over the container opening and subjected to rotational downward compression movement by an ROPP capping head. The outer sleeve of the closure shell is then roll-formed, simultaneously securing the internally threaded sealing assembly in place with the container neck. As the closure is fully tightened onto the container, the insert portion remains in a stationary preloaded engagement against the sealing surface, ensuring that the skirt portion is biased against the inner wall region of the opening to create an effective seal. The two-start thread configuration of the cap portion ensures that the closure can be applied with reduced rotational effort while distributing mechanical loads evenly across the threaded engagement.

Alternatively, the closure may be applied manually in applications where an ROPP is not required or no machine available. In this case, the user aligns the closure with the container neck and rotates it until the internal two-start thread of the cap portion fully engages with the external thread of the container. Alternatively, the sealing assemble 100 can also applied by hand without the closure shell 106. The reduced number of turns required for full engagement allows for ease of application while still ensuring that the insert portion is properly compressed against the sealing surface. In this manual application, the insert portion rotates in conjunction with the cap portion until contacting an opening then becoming stationary, during tightening, further embedding into the sealing interface and enhancing its engagement. The ability to apply the closure manually broadens its usability, making it suitable for home brewing, small-scale sparkling beverage production, or other applications where industrial capping equipment is not available.

Once applied, whether by ROPP machinery or manual threading, the closure maintains a secure and pressure-resistant seal, ensuring the integrity of the container contents. In pressurized applications, in a safe control environment is capable of 20 bar 300 psi internal gas pressure of the fluid within the container acts upon the flexible skirt portion of the insert, forcing it outwardly against the inner wall of the opening and reinforcing the primary sealing engagement. This pressure-assisted attribute forms a secondary sealing mechanism enhances the closure's ability to withstand high internal pressures, such as those encountered in carbonated beverages, while also enabling the system to remain secure under elevated temperatures, including pasteurization conditions. The annular retention flange prevents axial displacement of the insert portion, ensuring that the sealing integrity remains uncompromised even under conditions of pressure fluctuation or mechanical stress.

Upon opening, the closure releases pressure in a controlled manner. As the cap portion is rotated counterclockwise, the two-start thread enables a smooth disengagement from the container neck with minimal rotational effort. This safely prevents sudden pressure releases, which could otherwise cause unwanted splashing or foaming of the container contents. Once fully disengaged, the closure may be reapplied, with the insert portion returning to its preloaded engagement against the sealing surface upon re-tightening. The flexibility of the thermoplastic elastomer material used in the insert portion allows the closure to be used multiple times while maintaining its sealing effectiveness, thereby enabling reusability and resealing functionality.

Thus, the disclosed sealing assembly, in conjunction with its method of manufacture and application, provides a closure system that is both highly effective in maintaining a secure and pressure-resistant seal while also offering adaptability across various usage scenarios. Whether implemented in high-speed automated bottling lines or manually applied by individual users, the closure ensures reliable sealing performance, controlled safe pressure venting, and the ability to be resealed and reused.

### Experimental Validation and Test Results

To further validate the effectiveness of the present invention, a series of laboratory and in-field tests were conducted to evaluate the sealing integrity, pressure resistance, material performance, and manufacturing efficiency of the disclosed closure system. A 3D-printed aluminium replica of a container neck featuring a two-start thread configuration was fabricated, and the sealing assembly was applied and tested under controlled conditions. The assembled closure was placed in a water tank, and CO₂ gas pressure was gradually increased using a precision pressure regulator. The system was successfully tested up to 300 PSI (20 Bar) with no observed leakage or bubble formation, confirming the ability of the flexible skirt portion to maintain an effective seal under extreme pressurization.

Independent validation testing from the Australian Wine Research Institute (AWRI) laboratories have confirmed the sealing assembly insert, creditability for OTR, permeability, CO2 retention. Further in-field tests highlight the sealing assembly closure remains functionally stable under pasteurization conditions up to 72 °C, demonstrating high thermal resistance and long-term sealing reliability. The material selection was rigorously assessed through a series of mechanical load tests, where NORYL-GFN2 was shown to provide superior tensile strength and reduced thermal expansion compared to alternative plastic formulations. Additional structural evaluations highlighted the advantages of the two-start thread configuration, confirming that the dual engagement points provide enhanced load distribution, increased axial strength, and reduced removal torque requirements, for the application and removal process.

Furthermore, testing of the manufacturing and molding processes verified the efficiency of the spindle face design, with 40 circumferential grooves die engagement, confirming that the closure can be extracted smoothly from the mold without requiring ejector pins, thereby simplifying production and reducing costs. The grooves were also observed to facilitate controlled air venting during high-speed assembly, preventing pressure fluctuations that could otherwise compromise closure integrity. Additionally, the groove structure effectively absorbed excess adhesive during cap assembly, ensuring consistent bonding while maintaining a clean and uniform attachment within the closure shell.

These experimental results substantiate the superior performance of the disclosed sealing assembly, demonstrating its ability to maintain a high-pressure seal, withstand thermal processing, and provide efficient application in both industrial and manual settings. The combination of structural enhancements, material selection, and manufacturing efficiency makes the present invention a significant advancement over existing closure technologies, offering enhanced durability, reusability, and market adaptability across a wide range of pressurized beverage applications.

The present invention provides a sealing assembly for a closure that incorporates enhanced mechanical stability, improved sealing performance, and greater application versatility compared to conventional closure systems. The innovative design features a two-start thread configuration, a preloaded flexible insert portion, and a structurally reinforced cap portion, offering multiple functional benefits across industrial and manual bottling applications. The key advantages of the present invention include:
1. Enhanced Sealing Integrity:
   The insert portion features a flexible skirt and circumferential sealing fin, ensuring optimal contact with the inner wall region of the container opening.
   Under pressurized conditions, the skirt expands outwardly, reinforcing the seal and preventing leakage even at pressures up to 300 PSI (20 Bar).
   The preloaded engagement between the cap and insert portions maintains a consistent, reliable seal, overcoming any container opening manufacturing sealing face tolerance irregularities due to the flexible fin engagement, reducing the risk of pressure loss over time if any.
2. Two-start Thread for Balanced Load Distribution
   The internal two-start thread design ensures simultaneous engagement at two opposite points, reducing stress concentration and improving axial alignment during closure application.
   The reduced pitch and increased thread engagement length provide superior mechanical strength and resistance to axial loading, preventing thread failure under high-pressure conditions. The innovative 2-start thread profile design, by using a small thread pitch, does provide an additional linear length of thread area, all of which contributes to the increase percentagewise, overall strength for the cap assembly and the glass thread neck finish. Furthermore, the design thread tolerance structural feature provides for a slightly looser, consistent clearance fit upon application without compromising any thread tensile integration, accommodating a high-pressure solution
   Compared to single-start threads, the two-start configuration reduces the number of turns required to fully close the cap, improving efficiency in high-speed capping operations.
3. Compatibility With Ropp and Manual Application
   The closure is designed for seamless integration with Roll-On Pilfer-Proof (ROPP) machinery, ensuring high-speed, automated application for mass production.
   Unlike previous designs, the two-start thread closure can also be manually screwed onto a container neck, making it suitable for small-scale and home brewing applications.
   The ability to function without an ROPP head broadens its usability for craft beverage markets, specialty bottling, and reusable packaging applications.
4. Improved Manufacturing and Assembly Efficiency
   The circumferential grooves on the cap portion serve multiple purposes:
      Mold Extraction: Enables smooth cap removal from the mold without ejector pins, reducing complexity and cost.
      Air Venting: Prevents piston compression effects during high-speed closure assembly.
      Glue Reservoir: Captures excess adhesive, ensuring clean and secure bonding within the closure shell.
   The spindle face design of the two-start thread facilitates self-extraction, eliminating the need for additional tooling or mechanical intervention.
5. High Thermal Stability and Material Performance
   The cap portion is made from NORYL-GFN2, a glass-filled polymer with high tensile strength, reducing expansion and deformation under temperature fluctuations.
   The insert portion is formed from a thermoplastic elastomer (e.g., Santoprene™), or alike providing the necessary flexibility for dynamic sealing engagement.
   Laboratory, in-field tests confirmed that the closure maintains its sealing integrity even at 72 °C pasteurization conditions, making it suitable for heat-treated beverages.
6. Controlled Pressure Release and Resealability
   The preloaded insert portion allows for controlled safe, user-friendly pressure venting upon cap removal, minimizing the risk of sudden fluid ejection or foaming.
   The closure is resealable and reusable, maintaining an effective seal even after multiple openings and reapplications.
   The design supports sustainable packaging initiatives by reducing single-use closures in the beverage industry.

By combining enhanced sealing performance, improved manufacturing efficiency, and broad application compatibility, the present invention overcomes the limitations of prior closure systems while providing a robust, pressure-resistant, safe user-friendly sealing solution. The disclosed improvements position this sealing assembly as a superior alternative for high-pressure beverage packaging, carbonated drinks, and reusable closure applications.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and the appended claims.

1. A sealing assembly for a closure, the closure for applying to an opening of a container of fluid, the sealing assembly comprising:
a substantially rigid cap portion for seating the sealing assembly within a roof portion of a closure shell, the cap portion including a flattened cylindrically shaped body and a downwardly extending cylindrical skirt, the cylindrical skirt incorporating an internal two-start thread for engagement with an external thread of the container; and
an insert portion attachable to the cap portion, the insert portion including a skirt portion, the skirt portion being flexible relative to the cap portion, the skirt portion operable to contact an inner wall region of the opening upon application of the closure to the opening;
wherein the cap portion includes a centrally disposed attachment region to which the insert portion is attached;
wherein the insert portion further comprises an annular retention flange positioned between the central attachment region and the skirt portion, the annular retention flange configured to engage a radially inwardly extending projection of the cap portion, thereby preventing axial movement of the insert portion relative to the cap portion while permitting relative rotation of the insert portion relative to the cap portion;
wherein the insert portion skirt is biased against the inner wall region of the opening upon application of the closure to the opening;
wherein the cap portion further comprises a plurality of circumferentially distributed grooves in an axial direction along an outer surface of the cylindrical skirt that are configured to facilitate air venting during application of the sealing assembly to the closure shell;
wherein the cap portion is adapted to maintain a preloaded engagement with the insert portion such that the sealing assembly remains securely positioned within the closure shell during ROPP (roll-on piffer-proof) roll forming application;
wherein the two-start thread configuration features two parallel thread paths that begin 180 degrees apart, each of the two parallel thread paths extending helically 360 degrees around the cylindrical skin through at least one complete revolution; and
wherein the two-thread engagement ensures that opposite points of contact are established simultaneously.

2. The sealing assembly of claim 1, wherein an annular shaped wall portion of the cap portion is received in a corresponding channel in the insert portion, the channel surrounding the central attachment region of the insert portion to increase the rigidity of a central region of the insert portion relative to the skirt portion of the insert portion.

3. The sealing assembly of claim 1, wherein the insert portion is permanently and rotatably attached to the cap portion such that the insert portion remains attached to the cap portion when the sealing assembly is removed from the opening.

4. The sealing assembly of claim 1, wherein the annular retention flange of the insert portion is formed as an integrally molded component of the insert portion.

5. The sealing assembly of claim 1, wherein the skirt portion of the insert portion is configured to flex radially outwardly upon application of the closure to the opening, enhancing sealing pressure between the insert portion and the inner wall region of the opening.

6. (canceled)

7. The sealing assembly of claim 1, wherein the cap portion is formed of a rigid polymeric material comprising a glass-filled polymer for enhanced strength and reduced thermal expansion.

8. The sealing assembly of claim 1, wherein the insert portion is formed of a thermoplastic elastomer to provide flexibility and sealing performance.

9. The sealing assembly of claim 1, wherein the two-start thread of the cap portion is configured to reduce the number of rotations required to fully secure the closure to the opening.

10. The sealing assembly of claim 1, wherein the two-start thread of the cap portion is configured to provide balanced load distribution during application and removal of the closure.

11. The sealing assembly of claim 1, wherein the two-start thread of the cap portion is configured to increase axial load-bearing strength and resistance to failure when subjected to internal pressure within the container.

12. The sealing assembly of claim 1, wherein the plurality of circumferentially distributed grooves in an axial direction along the cylindrical skirt of the cap portion are configured to facilitate air venting during application of the sealing assembly to the closure shell.

13. The sealing assembly of claim 12, wherein the grooves further function as a glue reservoir to accommodate excess adhesive used to secure the insert portion to the cap portion.

14. The sealing assembly of claim 1, wherein the cap portion and insert portion are adapted for assembly within a roll-on tamper-evident closure applied to the opening using a roll-on pilfer-proof (ROPP) capping head.

15. The sealing assembly of claim 1, wherein the cap portion and insert portion are adapted for manual application without requiring a roll-on pilfer-proof (ROPP) capping head.

16. The sealing assembly of claim 1, wherein the cap portion and insert portion together form a resealable and reusable closure for the container.

17. A method for sealing an opening of a container containing a fluid, the method comprising:
applying a closure to the opening, the closure comprising a sealing assembly that includes a cap portion and an insert portion, the cap portion including a flattened cylindrically shaped body and a downwardly extending cylindrical skirt, the cylindrical skirt incorporating an internal two-start thread for engagement with an external thread of the container, and the insert portion including a skirt portion, the skirt portion being flexible relative to the cap portion and operable to contact an inner wall region of the opening upon application of the closure to the opening;
wherein the cap portion includes a centrally disposed attachment region to which the insert portion is attached, the insert portion further comprising an annular retention flange positioned between the central attachment region and the skirt portion, the annular retention flange configured to engage a radially inwardly extending projection of the cap portion, thereby preventing axial movement of the insert portion relative to the cap portion while permitting relative rotation of the insert portion relative to the cap portion;
wherein the cap portion further comprises a plurality of circumferentially distributed grooves in an axial direction along an outer surface of the cylindrical skirt that are configured to facilitate air venting during application of the sealing assembly to the closure shell;
wherein the cap portion is adapted to maintain a preloaded engagement with the insert portion such that the sealing assembly remains securely positioned within a closure shell during ROPP (roll-on pilfer-proof) roll forming application;
wherein the two-start thread configuration features two parallel thread paths that begin 180 degrees apart, each of the two parallel thread paths extending belically 360 degrees around the cylindrical skirt through at least one complete revolution; and
wherein the two-thread engagement ensures that opposite points of contact are established simultaneously.

18. The method of claim 17, wherein the closure is applied to the opening using a roll-on pilfer-proof (ROPP) capping head.

19. The method of claim 17, wherein the closure is manually screwed onto the opening without requiring a roll-on pilfer-proof (ROPP) capping head.
